(19) United States
(12) Patent Application Publication
(10) Pub. No.: US 2013/0132443 A1
(43) Pub. Date: May 23, 2013

(54) STRUCTURE-SPECIFIC RECORD COUNT DATABASE OPERATIONS

(71) Applicants: Donald Hart, Foothill Ranch, CA (US); Kung Lin, Irvine, CA (US)

(72) Inventors: Donald Hart, Foothill Ranch, CA (US); Kung Lin, Irvine, CA (US)

(21) Appl. No.: 13/298,410

(22) Filed: Nov. 17, 2011

(51) Int. Cl. G06F 17/30

(52) U.S. Cl. 707/803; 707/E17.005

(57) ABSTRACT

Methods and systems are disclosed to perform record counts of particular structures without causing database-wide locking to occur while such counting is being performed. A Data Definition Language (“DDL”) syntax referred to as RECORDCOUNT is specified at the structure level to enable a particular structure to be locked for performance of record count operations without locking the global dataset record. Updates or deletions/insertions to other structures can still be made by locking the structures associated with the RECORDCOUNT operation and not the global dataset. Further, the RECORDCOUNT option can be added to existing structures to enable structure-specific locking for performance of record counts.

### TECHNICAL FIELD

The present disclosure relates generally to databases; in particular, the present disclosure relates to performing record counts without locking the global data set record.

### BACKGROUND

Data management and data storage operations are increasingly used both to store data and to capture relevant information regarding the data. For example, in a financial institution environment, banking account information is not only stored but is accessed and analyzed to provide relevant information for reports tailored to specific government agency audits. In analyzing stored data items, it is useful to retrieve the number of “records” in a particular structure or table. An example “record” in a financial institution context comprises a set of information related to a customer, such as, an account name, account number, type of account, e.g., savings or checking, account value, e.g., dollar amount, etc. In turn, various structures comprise records for certain contexts, such as a first table of accounts opened in a first timeframe and a second table of accounts opened in a second timeframe.

To retrieve the number of records in a particular structure, a count has often been performed dynamically in response to each update to a record and/or has been performed in response to a request for a record count. Performing a dynamic count, however, diverts system resources away from other operations. Further, a significant lag in time between the request and response for the count information can often result due to requests and updates being queued for processing in the order in which they are received.

Alternatively, a count data item may be declared in the global data set for a particular schema to capture the record count of a disjoint structure. The count data items are thus global data items themselves. Through count data items, the database maintains an accurate dynamic count without employing a physical count provided in response to a request. However, because the count data items are global data items, any and all updates to a count data item require locking of the entire global data set record. Further, updates to a record in a specific structure may be placed in a database-wide queue. The record count for the specific structure is not updated until other updates ahead in the queue are processed and may be inaccurate if other updates to the structure are later in the queue. A lag in record count updates thus occurs.

Further, global, or database-wide, locking consumes resources and prevents other database operations from executing during the lock. As a result, the overhead expense and resulting lack of resources associated with global locking is staggering when a system comprises multiple structures and records in very large databases. Such problems are exacerbated further when frequent updates and/or additions/deletions are made to particular records. Further yet, the use of count data items can be limiting in that users are not able to add new count data items to an existing structure. Rather, count data items can only be added concurrently with the creation of the associated structure.

For these and other reasons, improvements are desirable. Although specific problems have been addressed in this Background, this disclosure is not intended in any way to be limited to solving those specific problems.

### SUMMARY

In accordance with the following disclosure, the above and other issues are addressed by the following:

In a first aspect, a method is disclosed for creating a database comprising a first database structure, the first database structure comprising a Data Definition Language (“DDL”) syntax for RECORDCOUNT, wherein RECORDCOUNT provides for structure-specific locking while performing a record count database operation. The method includes adding (or deleting or modifying, for example) a record to the first database structure, wherein the first database structure comprises at least one record. The method further includes determining if RECORDCOUNT is activated/enabled for the first database structure. If RECORDCOUNT is activated for the first database structure, the method comprises locking the first database structure, counting the records in the first database structure to determine a total number of records in the first database structure, and providing the total number of records counted.

In a second aspect, a computer system for performing structure-specific locking for a record count database operation is disclosed. The computer system includes at least one processing unit and memory. The memory stores computer executable instructions that, when executed by the at least one processing unit, perform a method of defining a DDL syntax for RECORDCOUNT which operates on a first structure in the database, wherein the first structure comprises at least a first record. The method further comprises adding a second record to the first structure and determining if RECORDCOUNT is enabled for the first structure. If RECORDCOUNT is enabled for the first structure, the method comprises locking the first structure, determining a total number of records in the first structure, providing the total number of records in the first structure, and providing a timestamp identifying a time value of when the total number of records in the first structure was determined.

In a third aspect, a non-transitory computer readable medium comprising a database function for counting records is disclosed. The database function comprises the following: function syntax, activation syntax, and structure syntax. The function syntax comprises a string specifying the name RECORDCOUNT, wherein RECORDCOUNT comprises instructions to count a number of records in a first structure, the instructions, when executed: locking the first structure, counting the number of records in the first structure, providing the number of records in the first structure, and providing a timestamp identifying a time of performance of the counting of the number of records in the first structure. Further, the activation syntax comprises a binary value to cause at least one processing unit to perform the function RECORDCOUNT. In addition, the structure syntax defines a database structure upon which the RECORDCOUNT function executes.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram illustrating an example embodiment of an environment or system for performing a record count operation;

FIG. 2 is an illustration of a further example embodiment of a system environment showing a server connected to a disk subsystem;

FIG. 3 is an example representation of structures illustrating example records;

FIG. 4 is an example railroad diagram including DDL RECORDCOUNT syntax showing activation features, according to a possible embodiment;

FIG. 5 is a flow diagram illustrating an example embodiment of a method for creating a DDL syntax for RECORDCOUNT for a specific structure;

FIG. 6 is a flow diagram illustrating an example embodiment of a method for adding RECORDCOUNT to an existing structure;

FIG. 7 is a flow diagram illustrating an example embodiment of a method for receiving an update to a structure, determining whether RECORDCOUNT is activated and, if so, performing structure-specific locking;

FIG. 8A is a flow diagram illustrating an example embodiment of a method for receiving a request for the number of records associated with a specific structure, determining whether RECORDCOUNT is activated and, if so, performing a record count with structure-specific locking;

FIG. 8B is a flow diagram illustrating an example embodiment of a method for receiving a request to execute the function RECORDCOUNT, according to a possible embodiment;

FIG. 9 is a flow diagram illustrating an example embodiment of a method for performing a record count check through the CHECKRECORDCOUNT function;

FIG. 10 is an example railroad diagram including DDL CHECKRECORDCOUNT syntax, according to a possible embodiment; and

FIG. 11 is a block diagram illustrating example physical details of an electronic computing device, with which aspects of the present disclosure can be implemented.

### DETAILED DESCRIPTION

Various embodiments of the present disclosure will be described in detail with reference to the drawings, wherein like reference numerals represent like parts and assemblies throughout the several views. Reference to various embodiments does not limit the scope of the disclosure, which is limited only by the scope of the claims attached hereto. Additionally, any examples set forth in this specification are not intended to be limiting and merely set forth some of the many possible embodiments for the claimed disclosure.

The logical operations of the various embodiments of the disclosure described herein are implemented as: (1) a sequence of computer implemented steps, operations, or procedures running on a programmable circuit within a computer, and/or (2) a sequence of computer implemented steps, operations, or procedures running on a programmable circuit within a directory system, database, or compiler.

In general, the present disclosure relates to a DDL for defining record count operations with a structure-specific locking mechanism. In embodiments, a database management system is used to both create and manage database structures for data items. For example, the present form of Unisys Corporation's Database Management System, i.e., DMSII, is used in creating and/or building database structures for data items, in which such structures are created according to a logical model, for example, a relational, hierarchical, or network model. Further, such database structures are managed by database operations to maintain the structures and provide relevant data in response to requests from various application programs for accessing, retrieving, and/or changing the data items. Embodiments provide for the database management system operations related to record counts to be governed by a DDL syntax referred to as RECORDCOUNT. In an embodiment, the database management system DMSII has a DDL designated as Data And Structure Definition Language (“DASDL”). The RECORDCOUNT function may be a DASDL syntax, in accordance with embodiments of the present disclosure. The RECORDCOUNT function provides for capturing the record count of a specific structure while employing a locking mechanism that may lock only the specific structure, as opposed to locking the global dataset record. By locking the specific structure related to the record count request or update, system resources are significantly conserved and overall system efficiencies result. Such non-global locking mechanisms for record count operations may also be applied, in embodiments, to existing structures and thus result in increased flexibility in database management operations. Further, record count values may be checked for corruption through use of a DASDL syntax referred to as CHECKRECORDCOUNT, in which such syntax alerts system administrators to inaccuracies and thus results in increased reliability of system reporting operations.

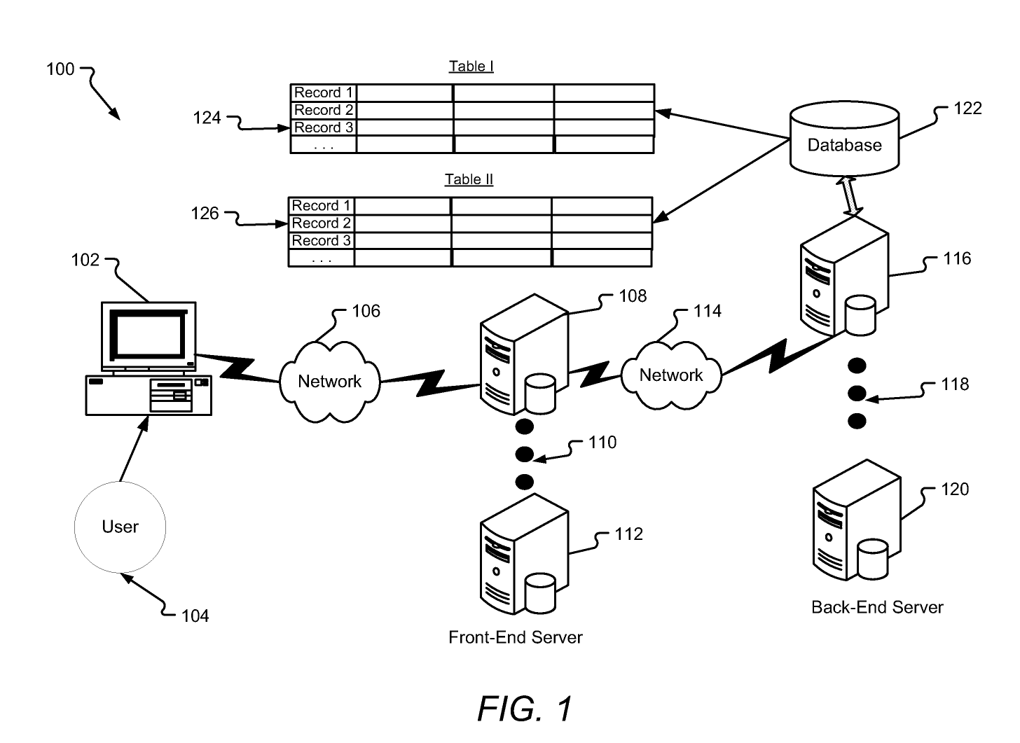

FIG. 1 is a block diagram illustrating an example embodiment of an environment or system 100 for performing a record count operation. A client or browser computer 102, such as used by user 104, for example, is connected by a network 106 to a front-end server 108. In embodiments, the front-end server 108 is a Web server or an application server. As shown in FIG. 1, a single front-end server 108 exists in embodiments. Other embodiments provide for multiple front-end servers or front-end server farms, as shown by front-end server 112 and ellipsis 110. In turn, front-end server 108 is connected to back-end database server 116 by network 114. In one embodiment, a single back-end database server 116 exists. In other embodiments, multiple back-end database servers or a back-end database server farm exist, as illustrated by ellipsis 118 and back-end database server 120. Back-end database server 116 communicates with database 122 which stores and manages data. For example, database 122 stores structures, including tables 124 and 126. These tables are shown in FIG. 1 as having records. Database 122 may retrieve tables 124 and 126 and/or manage these types of structures by adding/deleting records, modifying records, maintaining record counts, etc.

Logical environment 100 is not limited to any particular implementation. Rather, logical environment 100 encompasses any computing environment upon which the functionality of environment 100 may be practiced. While networks 106 and 114 are shown as individual networks, any types of networks conventionally understood by those of ordinary skill in the art may be used. For example, network 106 and/or network 114 may be the global network (e.g., the Internet or World Wide Web, i.e., “Web”). Network 106 and/or network 114 may also be a wide area network or a local area network, e.g., intranet. One or more standard packet-based formats, e.g., H.323, IP, Ethernet, and/or ATM may be used in communications over networks 106 and 114.

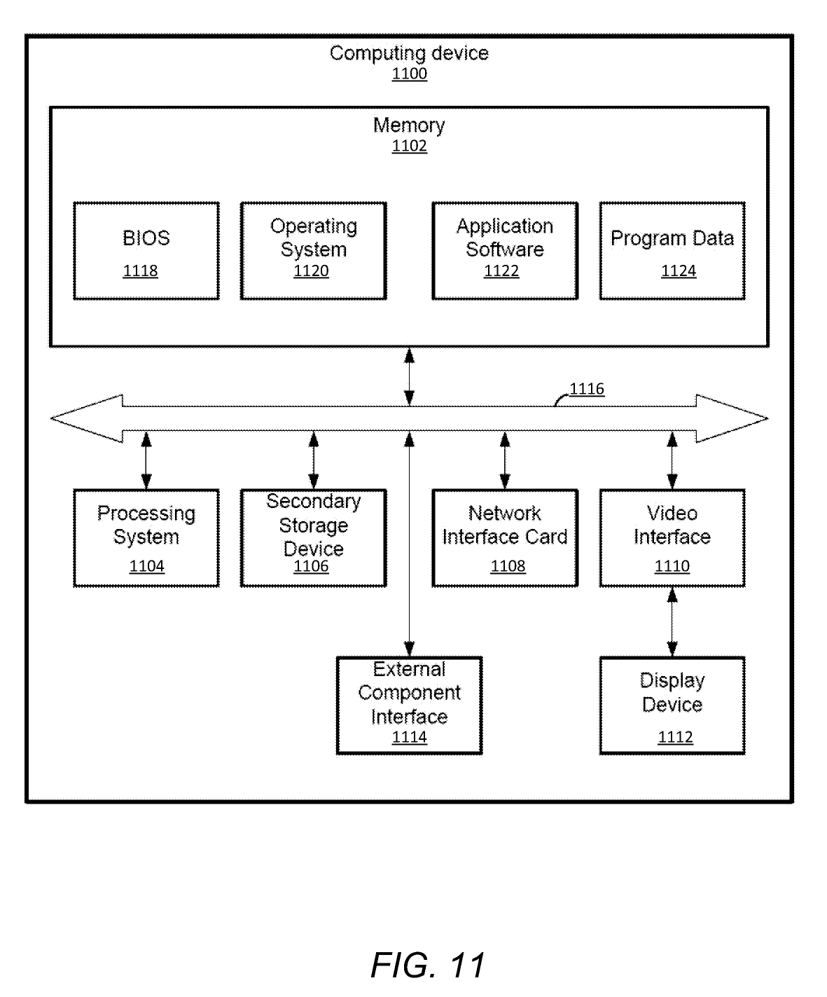

In addition, any type of environment or system may be used in embodiments. While environment or system 100 is illustrated in FIG. 1, embodiments cover any type of server, separate servers, server farm, etc. Further, any type of client computer 102 may be used. Although only one client computer 102 is illustrated in FIG. 1, another embodiment provides for multiple small computer devices to communicate with front-end server 108 by network 106. Yet other embodiments provide for each small computer device or client computer to communicate via a separate network to front-end server 108. Example environment 100 may be considered with respect to the specific components described, e.g., client computer, back-end database server, etc., or may be considered with respect to the analogous modules corresponding to such components. The components of the environment 100 may be computing systems as described in conjunction with FIG. 11.

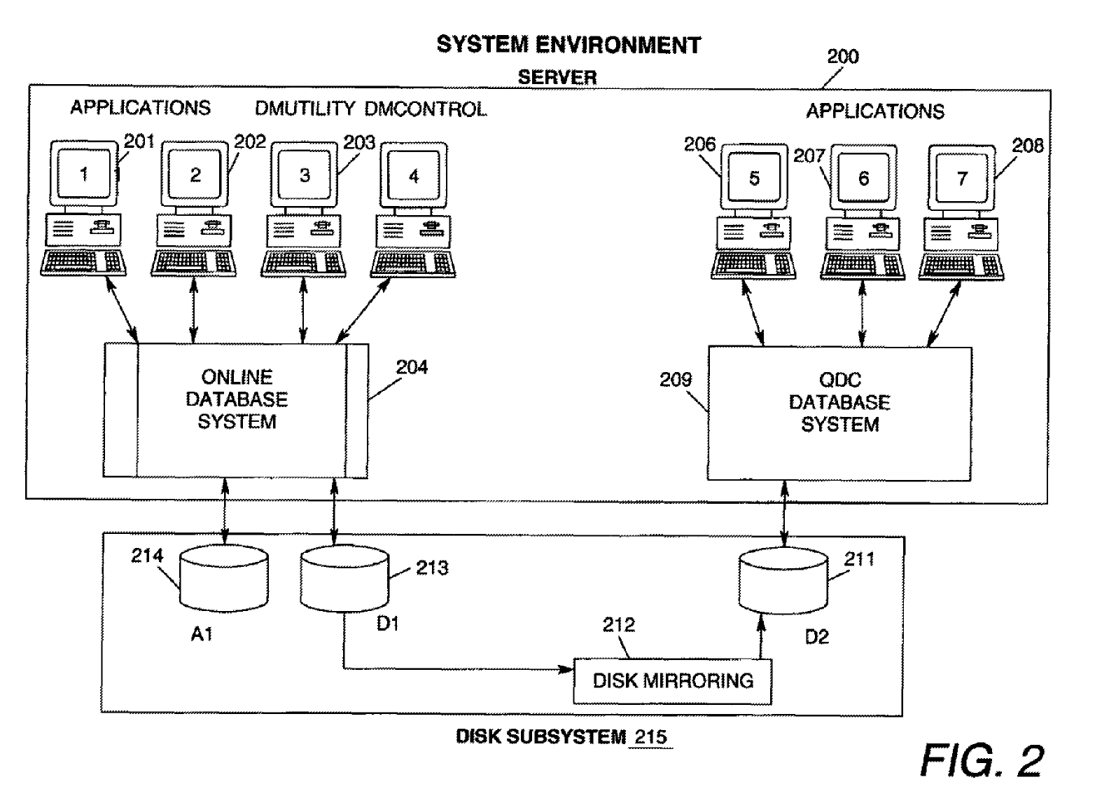

FIG. 2 is a further illustration of an embodiment of a system environment. The server 200 is used to run several different applications and utilizes the personal computer client-users 201, 202, and 203, which interact with and access the database system 204 within the server 200. Users, in this context, can include administrative users managing database structure and permissions, as well as applications which interact with the database. The server also utilizes the PC client-users 206, 207 and 208, which interact with and access the database system 209 (shown in this embodiment as QDC database system) within the single server 200.

Within the disk subsystem 215, the data files contained in the disk 213 (D1) are communicated back and forth with the primary online database system 204, and also optionally sent via the disk mirroring system 212 to disk (D2), 211. Disk (D2) 211, contains the mirrored database snapshot.

The data files of database system 204 are mirrored via system 212 and communicated to the secondary database system 209.

Although in this example system environment the server contains two separate database systems 204, 209, it is recognized that in the context of the present disclosure, only one database system may be present. Additionally, mirroring among disks 211, 213 may or may not occur in certain embodiments.

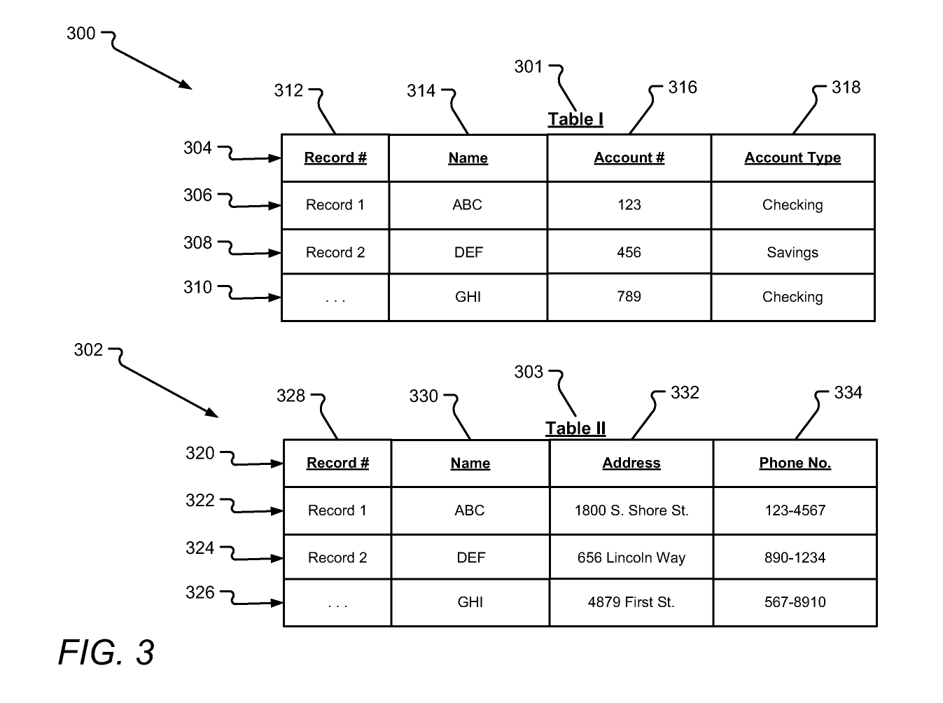

Turning to FIG. 3, an example representation of structures 300 and 302 illustrating example records is depicted in accordance with embodiments of the present disclosure. A structure may be any type of logical organization of data for storage and/or management means. For example, a structure may be a table comprising one or more rows and/or one or more columns, a hierarchical grouping of one or more parent nodes and/or one or more child nodes, a structure based on a relational model, a structure based on a network model, a logical structure based on a mapping to one or more objects, etc. Tables 300 and 302 illustrate two types of example structures for purposes of illustration only. Table 300 is labeled “Table I” 301, for example, while table 302 is labeled “Table II” 303, for example. Table 300 comprises multiple records 306, 308, 310, etc., in which each record comprises a set of information related to a target (e.g., a customer) with the subject information shown on row 304 of table 300. For example, table 300 comprises record number data 312, name of the customer 314, account number of the customer 316, and account type 318. The records 322, 324, and 326 shown in table 302 comprise data with subject information shown on row 320 as encompassing record number data 328, name of the customer 330, address of the customer 332, and phone number of the customer 334. The structures, records, and data shown in FIG. 3 are offered as examples of possible structures, records, etc., for the embodiments described. These examples are offered for purposes of illustration only and are not intended to be limiting.

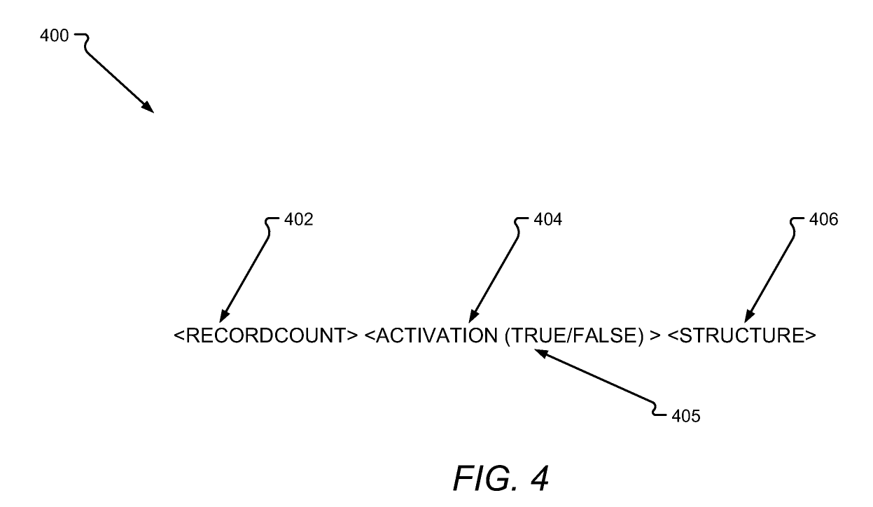

While FIG. 3 illustrates an example representation of structures illustrating example records, FIG. 4 is an example railroad diagram 400 including DDL RECORDCOUNT syntax, according to embodiments of the present disclosure. The RECORDCOUNT function can be used to obtain a record count of a particular structure while locking only the particular structure at issue. Thus, in the example illustration of FIG. 3, the record count of structure 300 may be obtained by locking structure 300 without locking structure 302. The RECORDCOUNT function can thus be used to provide the total number of records in a structure without locking the global dataset of the database. With RECORDCOUNT, updates to a record in a particular structure can be made by placing the updates and resulting record count update in a queue for the particular structure, as opposed to a database-wide queue where any changes to any structure are placed in an overall queue for the entire database. Thus, with RECORDCOUNT, only the relevant structure(s) is locked to provide such updates and record count. Such structure-specific locking is achieved by the new DDL syntax referred to as RECORDCOUNT. In embodiments, the DDL syntax is a DASDL syntax. According to further embodiments, the RECORDCOUNT function is valid for a disjoint dataset and set, in which the record count of a disjoint structure is obtained by having RECORDCOUNT operate on the disjoint structure. In other embodiments, the RECORDCOUNT function is valid for all types of datasets and structures.

Returning to the railroad diagram 400 depicted in FIG. 4, RECORDCOUNT 402 is a function to count records. In embodiments, RECORDCOUNT 402 is a structure physical option associated with a structure and/or is stored in a control file associated with the structure. In an embodiment where RECORDCOUNT is stored in a control file associated with the structure, a DMUTILITY LIST/WRITE command can be used to access the control file to allow the option for RECORDCOUNT to be set when creating the database, for example. In embodiments, the function syntax for RECORDCOUNT 402 comprises a string specifying the name RECORDCOUNT, in which the RECORDCOUNT function comprises instructions to count a number of records in a particular structure, according to an embodiment. Such instructions include, for example, locking the particular structure, counting the number of records in the particular structure, providing the number of records in the particular structure and providing a timestamp and/or datestamp identifying the time and/or date of performance of the counting of the number of records in the particular structure. In some embodiments, providing a timestamp and/or datestamp is optional.

Further, railroad diagram 400 depicts activation syntax 404, in which such syntax comprises a value to cause at least one processing unit to perform the function RECORDCOUNT. The value thus designates if RECORDCOUNT should operate on the particular structure. In an embodiment, a binary value comprises TRUE/FALSE 405. Thus, where RECORDCOUNT=TRUE, the function RECORDCOUNT is activated/enabled, and the function RECORDCOUNT will operate on the associated structure. On the other hand, where RECORDCOUNT=FALSE, the function RECORDCOUNT is not activated/not enabled. The binary value in another embodiment comprises ON/OFF. In yet another embodiment, a flag, number system (0|1), or other indicator is used to indicate if the RECORDCOUNT is activated/enabled.

Next, railroad diagram 400 illustrates structure syntax 306, in which such structure syntax 406 defines the database structure that is subject to the RECORDCOUNT function. The database structure defined by the structure syntax 306 is thus the structure upon which the RECORDCOUNT function will operate. In an embodiment, the database structure is predetermined by a user definition. In another embodiment, the database structure is automatically determined. In an example embodiment, structure syntax 406 comprises <global default>, <data set default>, <set-subset default>, etc. In embodiments, the structure syntax may comprise a table identifier or other type of structure identifier. Further, in embodiments where RECORDCOUNT is stored in a control file associated with the structure, the structure syntax may not be needed, as RECORDCOUNT will operate on the structure associated with the control file. In additional embodiments, RECORDCOUNT is included in every structure but only operates on those structures where the activation/enablement value indicates such function should be performed, e.g., RECORDCOUNT=TRUE. In yet further embodiments, the RECORDCOUNT function operates on whatever data is active in a display.

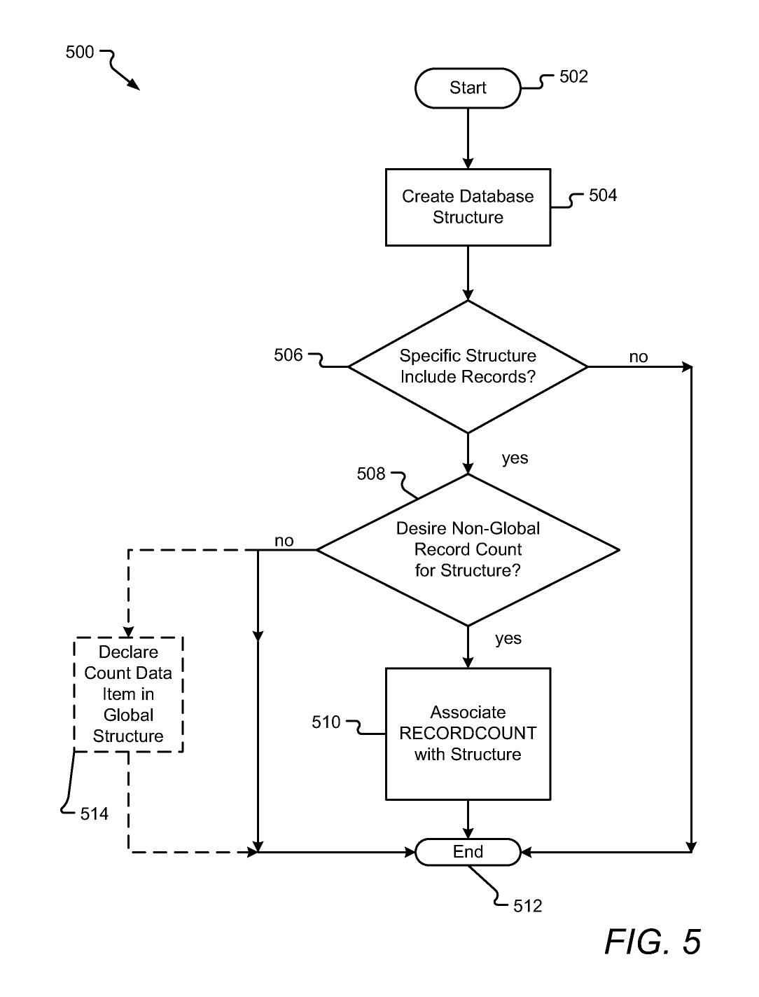

FIG. 5 next illustrates example operational steps 500 for creating a DDL RECORDCOUNT syntax for a specific structure, in accordance with embodiments disclosed herein. Process 500 is initiated at START operation 502 and proceeds to create a database structure 504. In an embodiment, a database developer creates a database structure 504 when building a database or updating an existing database or database system. Next, process 500 proceeds to query 506 to determine if the specific structure created in step 504 comprises one or more records. If the specific structure comprises records, process 500 proceeds YES to query 508 to determine if a non-global record count functionality for the specific structure is desired. If a non-global record count functionality is desired, process 500 proceeds YES to associate RECORDCOUNT with the specific structure 510. As discussed, associating RECORDCOUNT with the specific structure comprises defining, such as with structure syntax, the structure upon which the function RECORDCOUNT will execute. In an embodiment, the structure syntax comprises a table or structure identifier, for example. In further embodiments, RECORDCOUNT is stored in a control file associated with the structure, and no structure syntax is needed as RECORDCOUNT will operate on the structure associated with the control file. After associating RECORDCOUNT with the specific structure 510, process 500 terminates at END operation 512.

Returning to query 508, where non-global record count functionality is not desired for the specific structure, process 500 proceeds NO and terminates at END operation 512. Alternatively, process 500 may proceed as an optional step (as shown by dashed lines) to step 514 to declare a count data item in the global structure to hold the record count of the specific structure. Declaring a count data item in the global structure results in locking of the global data set record when any updates and/or count requests are made with respect to a particular structure.

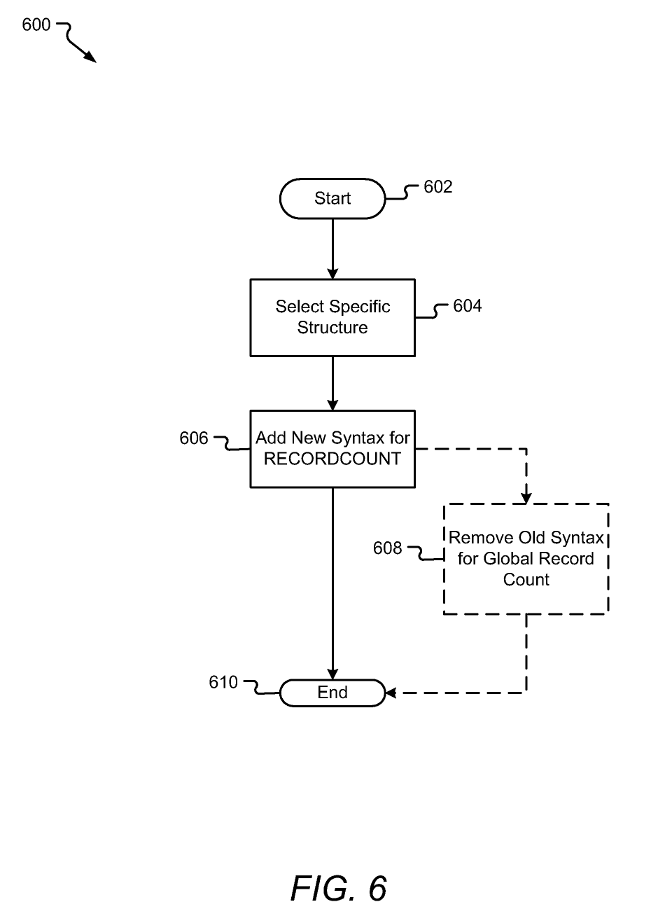

FIG. 6 next illustrates example operational steps 600 for performing a method for adding RECORDCOUNT functionality to an existing structure, in accordance with embodiments of the present disclosure. Process 600 is initiated at START operation 602 and proceeds to select specific structure 604, in which such specific structure already exists in the database or database system. Next, process 600 proceeds to add new syntax for RECORDCOUNT 606. Record count functionality is thus enabled by a new DDL (or DASDL in other embodiments) syntax referred to as RECORDCOUNT, now associated with the structure. In an embodiment, RECORDCOUNT is a structure physical option that enables record counts to be provided without locking the global data set record. After adding new syntax for RECORDCOUNT to the existing structure 606, process 600 optionally proceeds to remove old syntax for global record count functionality 608. For example, where a count data item, e.g., POPULATION item, was declared in the global data set to hold the record count of a disjoint structure, such count data items will be removed at step 608, according to embodiments disclosed herein. Process 600 then terminates at END operation 610.

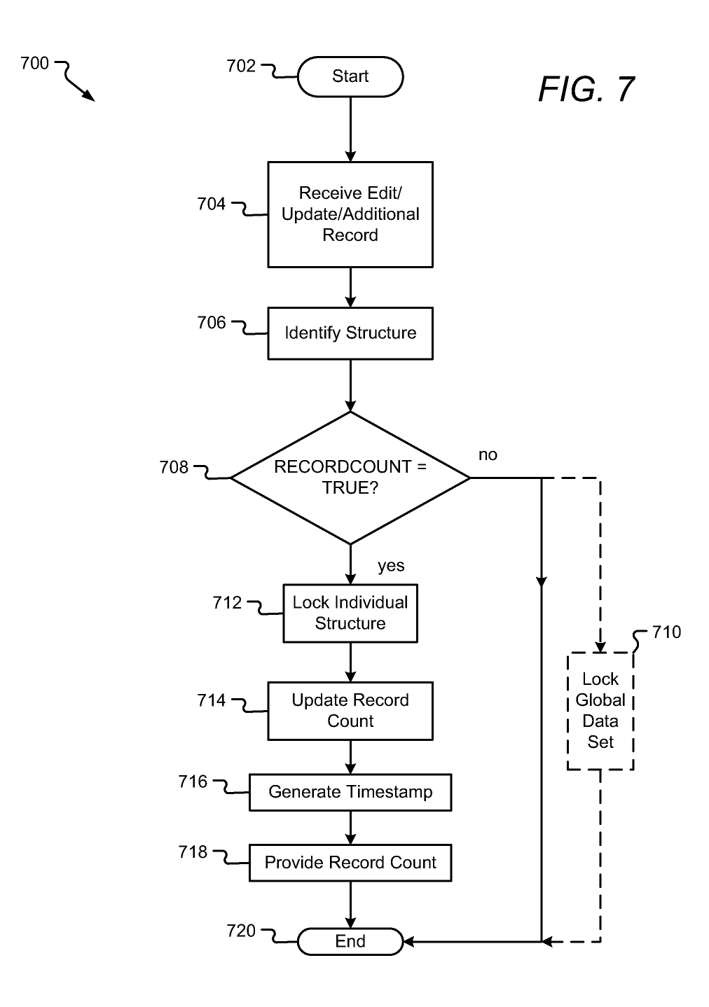

Turning to FIG. 7, example operational steps 700 are illustrated for performing a method for receiving an update to a structure, determining whether RECORDCOUNT is activated for the structure, and, if RECORDCOUNT is activated, performing structure-specific locking while performing a record count database operation, according to embodiments disclosed herein. Process 700 is initiated at START operation 702 and proceeds to receive edit/update/additional record step 704, in which an update, modification, insertion, deletion, etc., of a record is received. For example, a back-end database server 116, as depicted in FIG. 1, may receive such an edit/update from client computer 102 and communicate such request to database 122. Next, process 700 proceeds to step 706, in which the structure associated with the update is identified 706. After identifying the associated structure, process 700 proceeds to query 708 to determine if RECORDCOUNT is activated/enabled for the identified structure. For example, in an embodiment, it is determined whether RECORDCOUNT=TRUE for the identified structure. If RECORDCOUNT is activated for the specific structure, process 700 proceeds YES to lock individual structure 712. As discussed, the functionality of RECORDCOUNT enables the record count of the identified structure to be determined, and the structure locked, without locking the entire global data set record.

Update record count 714 next occurs, in which the records are counted and the record count is updated if changes exist from the previous record count. Such counting of the records occurs with locking of only the associated structure. A timestamp and/or datestamp can be generated 716 to indicate the time and/or date of performance of the record count for the particular structure. In some embodiments, step 716 for generating a timestamp and/or datestamp is optional (not shown). Finally, the data, e.g., record count and timestamp and/or datestamp, is provided 718. Thus, the record count may be displayed or output to a user interface for viewing by a user. Process 700 then terminates at END operation 720. In embodiments, after counting the records and updating the record count if changes exist, the individual structure may be unlocked to allow for further updates/changes (not shown). The record count may be completed dynamically (i.e., after any change(s)) or in response to a request for the record count by a user, according to embodiments.

Returning to query 708, where RECORDCOUNT is not activated/enabled, e.g., RECORDCOUNT=FALSE according to an embodiment, process 700 proceeds NO to END operation 720. Before proceeding to END operation 720, process 700 may optionally lock the global data set 710. The record(s) in the specific structure are next counted (not shown) while the global data set is locked. The total number of records determined for the specific structure may then be provided (not shown). While process 700 shows the locking of the global data set 710 as an optional step, other embodiments automatically lock the global data set to provide a response to the request for the record count where RECORDCOUNT is not activated. Where optional step 710 is performed, process 700 then terminates at END operation 720.

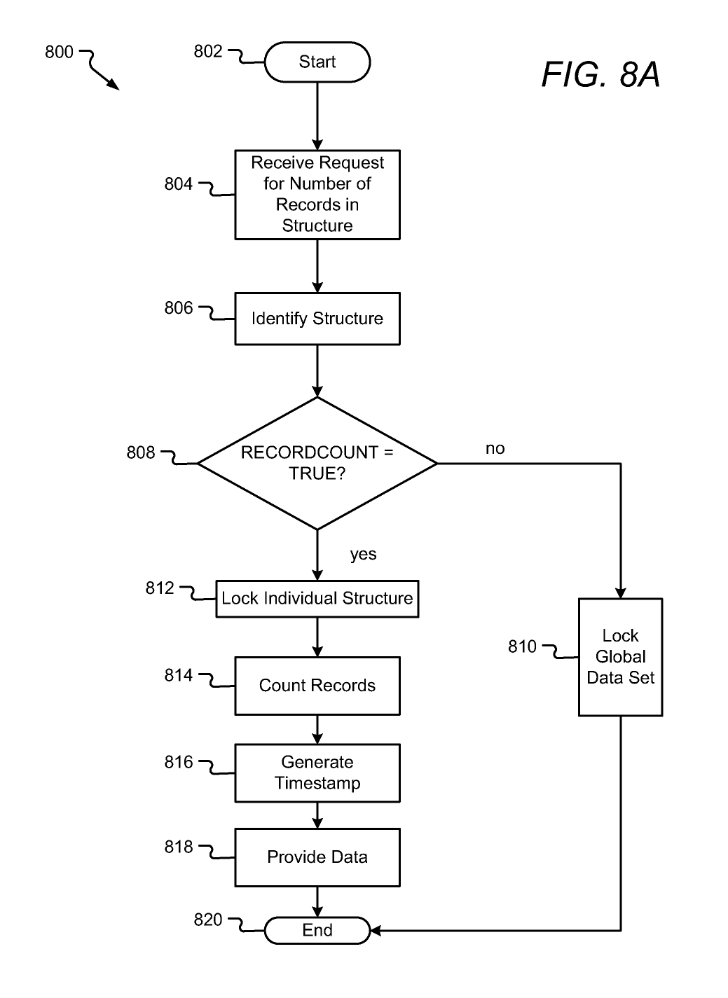

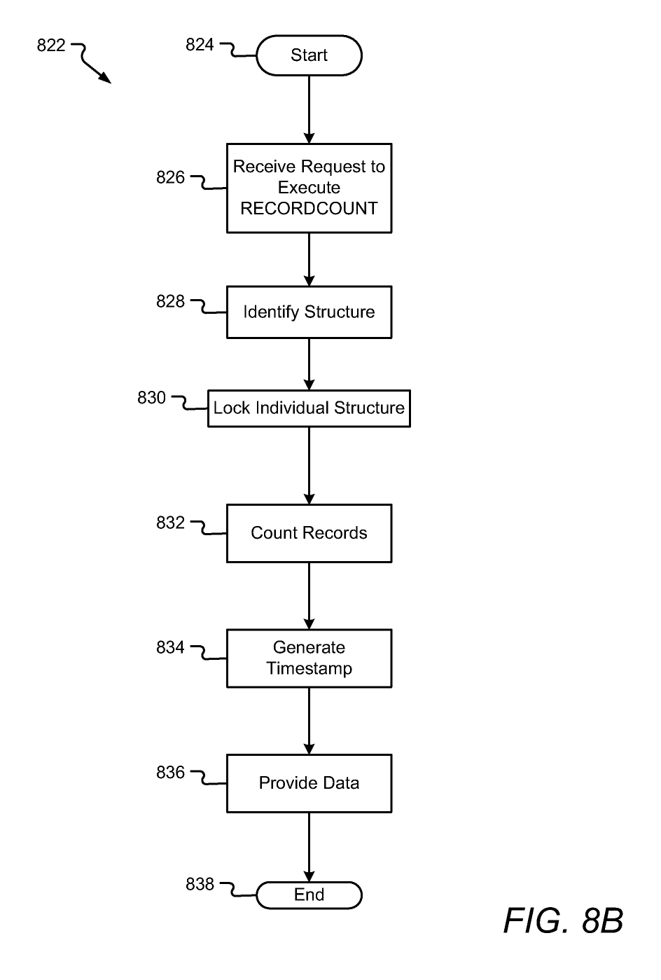

FIG. 8A next illustrates example operational steps 800 for performing a method for receiving a request for the number of records associated with a specific structure, determining whether RECORDCOUNT is activated for the structure, and, if RECORDCOUNT is activated, performing structure-specific locking while performing a record count database operation, according to embodiments disclosed herein. Process 800 is initiated at START operation 802 and proceeds to receive request for the number of records associated with a structure. For example, a back-end database server 116, as depicted in FIG. 1, may receive such request for the record count from client computer 102 and communicate such request to database 122. Next, process 800 proceeds to step 806, in which the structure associated with the request for the record count is identified 806. After identifying the associated structure, process 800 proceeds to query 808 to determine if RECORDCOUNT is activated/enabled for the identified structure. For example, in an embodiment, it is determined whether RECORDCOUNT=TRUE for the identified structure. If RECORDCOUNT is activated for the specific structure, process 800 proceeds YES to lock individual structure 812. As discussed, the functionality of RECORDCOUNT enables the record count of the identified structure to be determined and provided without locking the entire global data set record. The records associated with the identified structure are counted 814 without locking the global data set record. A timestamp and/or datestamp may be generated 816 to indicate the time and/or date of performance of the record count for the particular structure. In some embodiments, generation of the timestamp and/or datestamp 816 is optional (not shown). Next, the data, e.g., record count and timestamp and/or datestamp, is provided 818. In an embodiment, this data is provided 818 to the requestor. Finally, process 800 terminates at END operation 820.

Returning to query 808, where RECORDCOUNT is not activated/enabled, e.g., RECORDCOUNT=FALSE according to an embodiment, process 800 proceeds to lock global data set 810, in which the global data set record is locked 810 to allow the number of records in the specific structure to be determined. The record(s) in the specific structure are next counted and provided (not shown). Process 800 then terminates at END operation 820.

Turning to FIG. 8B, a method for receiving a request to execute the function RECORDCOUNT is illustrated in accordance with embodiments disclosed herein. Process 822 is initiated at START operation 824 and proceeds to step 826, in which a request to specifically execute the function RECORDCOUNT is received 826. In embodiments, such request is a command, for example, to execute RECORDCOUNT. In an embodiment, such command is received from a user, in which the user knows that RECORDCOUNT is enabled for the specific structure associated with the request. Next, the structure associated with the request to execute the RECORDCOUNT function is identified 828. The individual structure is locked 830, and the record(s) in the structure are counted 832. A timestamp and/or datestamp can be generated 834 to indicate the time and/or date of performance of the record count for the particular structure. In some embodiments, step 834 for generating a timestamp and/or datestamp is optional (not shown). Finally, the data, e.g., record count and timestamp and/or datestamp, is provided 836. Thus, the record count may be displayed or output to a user interface for viewing by a user. Process 822 then terminates at END operation 838.

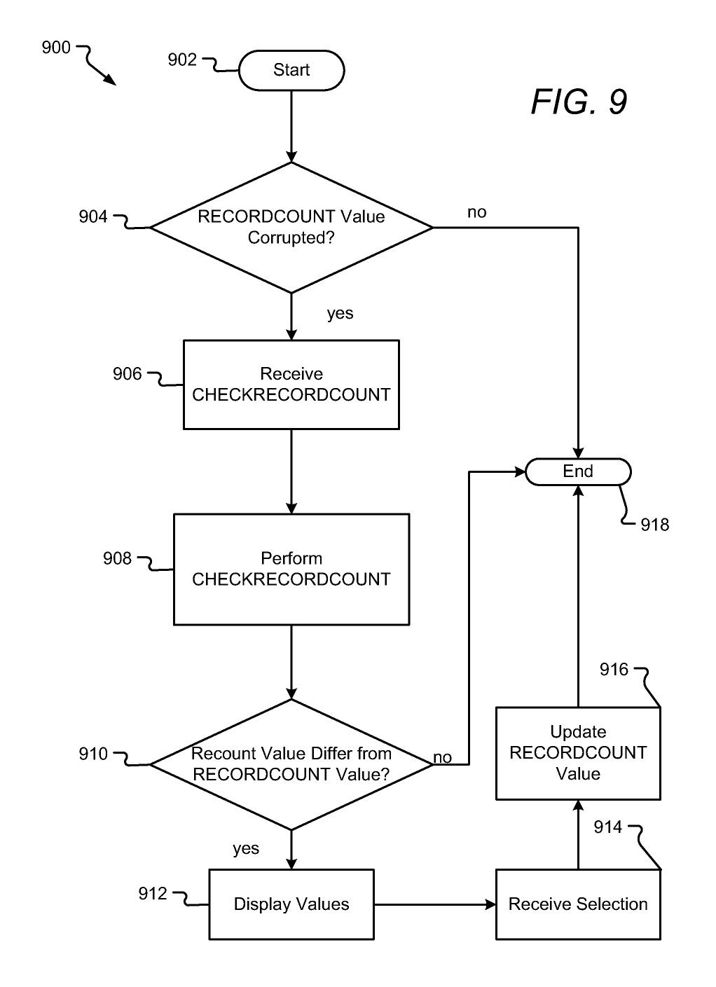

Next, FIG. 9 illustrates example operational steps 900 for a method for performing a record count check through the CHECKRECORDCOUNT function, in accordance with embodiments disclosed herein. Process 900 is initiated at START operation 902 and proceeds to query 904 to determine if the RECORDCOUNT value is corrupted. In an example embodiment, the RECORDCOUNT value becomes corrupted as a result of a hardware or system failure. In an embodiment, a user, such as a database administrator observes an error in the RECORDCOUNT value. In another embodiment, the database or back-end server automatically finds an error in the RECORDCOUNT value. If query 904 determines that the RECORDCOUNT value is corrupted, process 900 proceeds YES to receive CHECKRECORDCOUNT 906. For example, a command to execute the CHECKRECORDCOUNT function may be received from a client computer, such as client computer 102 in FIG. 1, through the front-end 108-112 and back-end servers 116-120, for example, and/or may be received from another workflow in the database operations, in accordance with example embodiments. Next, process 900 proceeds to CHECKRECORDCOUNT 908, in which a dynamic recount, or counting, of the records in the associated structure occurs. Query 910 then determines whether the recount value, or CHECKRECORDCOUNT value, differs from the RECORDCOUNT value originally examined at step 904. If there is no difference, process 900 terminates at END operation 918. If, however, the values differ, process 900 proceeds YES to display values 912, in which the recount value, or CHECKRECORDCOUNT value, and the RECORDCOUNT value as originally evaluated at step 904 are displayed to a user, in accordance with an embodiment. Upon evaluating the values, the user makes a selection of the value to be used, and the selection is received 914. The RECORDCOUNT value is then updated 916 with the selected value, and process 900 terminates at END operation 918.

FIGS. 5-9 are examples of possible operational characteristics shown in accordance with the embodiments disclosed herein. Operational steps depicted may be combined into other steps and/or rearranged. Further, fewer or additional steps may be used, for example.

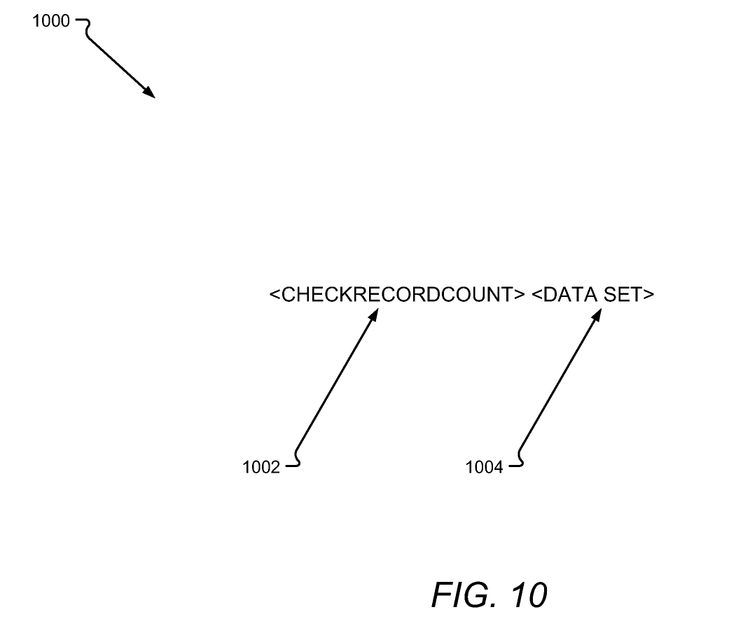

While FIG. 9 depicts a method for performing a record count check through the CHECKRECORDCOUNT function, FIG. 10 illustrates an example railroad diagram including DDL CHECKRECORDCOUNT syntax, in accordance with an embodiment disclosed herein. As shown in FIG. 10, a railroad diagram to allow for the reorganization and reestablishment of a correct record count comprises, in an embodiment, function syntax for CHECKRECORDCOUNT 1002. The function syntax for CHECKRECORDCOUNT 1002 comprises a string specifying the name CHECKRECORDCOUNT, in which CHECKRECORDCOUNT comprises instructions to count a number of records in a particular structure to reestablish a correct record count, according to an embodiment. Such instructions include, for example, counting the number of records in the particular structure to provide a CHECKRECORDCOUNT value. The CHECKRECORDCOUNT value is then compared with the RECORDCOUNT value to determine if a difference exists, according to embodiments, as discussed above. Railroad diagram 1000 also comprises data set syntax 1004 according to embodiments, in which data set syntax 1004 designates the set of data and/or data structure upon which to execute the CHECKRECORDCOUNT function. In another embodiment, a table or structure identifier is used instead of a specified data set. In yet another embodiment, the CHECKRECORDCOUNT function operates on whatever data is active in a user interface display.

While railroad diagrams 400 and 1000 illustrate syntax examples according to the embodiments depicted, these syntax examples are offered for purposes of illustration only. Additional syntax, different syntax, different ordering of syntax, fewer syntax, etc. may be used in accordance with embodiments disclosed herein. The railroad diagrams 400 and 1000 are examples only.

FIG. 11 is a block diagram illustrating an example computing device 1100. In some embodiments, the client computer 102, one or more servers 108, 110, 112, 116, 118, and 120, database systems 204 and 209, and computer clients 201-203 and 206-208 are implemented as one or more computing devices like the computing device 1100. It should be appreciated that in other embodiments, the client computer 102, one or more servers 108, 110, 112, 116, 118, and 120, database systems 204 and 209, and computer clients 201-203 and 206-208 are implemented using computing devices having hardware components other than those illustrated in the example of FIG. 11.

The term computer readable media as used herein may include computer storage media and communication media. As used in this document, a computer storage medium is a device or article of manufacture that stores data and/or computer-executable instructions. Computer storage media may include volatile and nonvolatile, removable and non-removable devices or articles of manufacture implemented in any method or technology for storage of information, such as computer readable instructions, data structures, program modules, or other data. By way of example, and not limitation, computer storage media may include dynamic random access memory (DRAM), double data rate synchronous dynamic random access memory (DDR SDRAM), reduced latency DRAM, DDR2 SDRAM, DDR3 SDRAM, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

In the example of FIG. 11, the computing device 1100 includes a memory 1102, a processing system 1104, a secondary storage device 1106, a network interface card 1108, a video interface 1110, a display unit 1112, an external component interface 1114, and a communication medium 1116. The memory 1102 includes one or more computer storage media capable of storing data and/or instructions. In different embodiments, the memory 1102 is implemented in different ways. For example, the memory 1102 can be implemented using various types of computer storage media.

The processing system 1104 includes one or more processing units. A processing unit is a physical device or article of manufacture comprising one or more integrated circuits that selectively execute software instructions. In various embodiments, the processing system 1104 is implemented in various ways. For example, the processing system 1104 can be implemented as one or more processing cores. In another example, the processing system 1104 can include one or more separate microprocessors. In yet another example embodiment, the processing system 1104 can include an application-specific integrated circuit (ASIC) that provides specific functionality. In yet another example, the processing system 1104 provides specific functionality by using an ASIC and by executing computer-executable instructions.

The secondary storage device 1106 includes one or more computer storage media. The secondary storage device 1106 stores data and software instructions not directly accessible by the processing system 1104. In other words, the processing system 1104 performs an I/O operation to retrieve data and/or software instructions from the secondary storage device 1106. In various embodiments, the secondary storage device 1106 includes various types of computer storage media. For example, the secondary storage device 1106 can include one or more magnetic disks, magnetic tape drives, optical discs, solid state memory devices, and/or other types of computer storage media.

The network interface card 1108 enables the computing device 1100 to send data to and receive data from a communication network. In different embodiments, the network interface card 1108 is implemented in different ways. For example, the network interface card 1108 can be implemented as an Ethernet interface, a token-ring network interface, a fiber optic network interface, a wireless network interface (e.g., WiFi, WiMax, etc.), or another type of network interface.

The video interface 1110 enables the computing device 1100 to output video information to the display unit 1112. The display unit 1112 can be various types of devices for displaying video information, such as a cathode-ray tube display, an LCD display panel, a plasma screen display panel, a touch-sensitive display panel, an LED screen, or a projector. The video interface 1110 can communicate with the display unit 1112 in various ways, such as via a Universal Serial Bus (USB) connector, a VGA connector, a digital visual interface (DVI) connector, an S-Video connector, a High-Definition Multimedia Interface (HDMI) interface, or a DisplayPort connector.

The external component interface 1114 enables the computing device 1100 to communicate with external devices. For example, the external component interface 1114 can be a USB interface, a FireWire interface, a serial port interface, a parallel port interface, a PS/2 interface, and/or another type of interface that enables the computing device 1100 to communicate with external devices. In various embodiments, the external component interface 1114 enables the computing device 1100 to communicate with various external components, such as external storage devices, input devices, speakers, modems, media player docks, other computing devices, scanners, digital cameras, and fingerprint readers.

The communications medium 1116 facilitates communication among the hardware components of the computing device 1100. In the example of FIG. 11, the communications medium 1116 facilitates communication among the memory 1102, the processing system 1104, the secondary storage device 1106, the network interface card 1108, the video interface 1110, and the external component interface 1114. The communications medium 1116 can be implemented in various ways. For example, the communications medium 1116 can include a PCI bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing system Interface (SCSI) interface, or another type of communications medium.

The memory 1102 stores various types of data and/or software instructions. For instance, in the example of FIG. 11, the memory 1102 stores a Basic Input/Output System (BIOS) 1118 and an operating system 1120. The BIOS 1118 includes a set of computer-executable instructions that, when executed by the processing system 1104, cause the computing device 1100 to boot up. The operating system 1120 includes a set of computer-executable instructions that, when executed by the processing system 1104, cause the computing device 1100 to provide an operating system that coordinates the activities and sharing of resources of the computing device 500. Furthermore, the memory 1102 stores application software 1122. The application software 1122 includes computer-executable instructions, that when executed by the processing system 1104, cause the computing device 1100 to provide one or more applications. The memory 1102 also stores program data 1124. The program data 1124 is data used by programs that execute on the computing device 1100.

Overall, a number of advantages of the methods and systems of the present disclosure exist and are described throughout the disclosure. For example, structure-specific locking for record count operations conserves system resources by not causing database-wide locking when conducting dynamic record counts. Improved database operation performance and other efficiencies thus result from such conservation of database resources. Further, having structure-specific queues for updating records and generating resulting record counts creates greater efficiencies by reducing response time to record count requests because changes to other structures are not included in the queue for a particular structure. Additional information for conducting record count analyses is also provided by the providing of timestamps/datestamps with record count results. Further, the flexibility provided by the ability to add the new RECORDCOUNT syntax to existing structures eliminates limitations previously encountered by having to include data item counts at the time of creating the associated structures. In addition, corrupted RECORDCOUNT values resulting from hardware failures, for example, can be pinpointed through the use of CHECKRECORDCOUNT syntax, thus resulting in improved response times to system failures. Additional advantages exist as well.

The various embodiments described above are provided by way of illustration only and should not be construed as limiting. Those skilled in the art will readily recognize various modifications and changes that may be made without following the example embodiments and applications illustrated and described herein. For example, the operations shown in the figures are merely examples. In various embodiments, similar operations can include more or fewer steps than those shown in the figures. Furthermore, in other embodiments, similar operations can include the steps of the operations shown in the figures in different orders. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-implemented method for creating a database comprising a first database structure, the first database structure comprising a Data Definition Language (“DDL”) syntax for RECORDCOUNT, wherein RECORDCOUNT provides for structure-specific locking while performing a record count database operation, the method comprising:
adding a record to the first database structure, wherein the first database structure comprises at least one record;
determining if RECORDCOUNT is activated for the first database structure; and
if RECORDCOUNT is activated for the first database structure:
locking the first database structure;
counting the records in the first database structure to determine a total number of records in the first database structure; and
providing the total number of records counted.

2. The method of claim 1, further comprising:
providing a timestamp with the providing of the total number of records counted, wherein the timestamp identifies a time value of when the total number of records in the first database structure was determined.

3. The method of claim 1, further comprising:
maintaining a second database structure, wherein the second database structure comprises a plurality of records; and
not locking the second database structure while locking the first database structure.

4. The method of claim 3, wherein RECORDCOUNT is stored in a control file.

5. The method of claim 3, wherein the determining if RECORDCOUNT is activated for the first database structure comprises:
determining if RECORDCOUNT=TRUE.

6. The method of claim 3, further comprising:
determining a value for RECORDCOUNT is corrupted;
checking the value for RECORDCOUNT by employing a CHECKRECORDCOUNT option to provide a CHECKRECORDCOUNT value; and
if the value for RECORDCOUNT and the value for CHECKRECORDCOUNT differ:
displaying the value for RECORDCOUNT and the value for CHECKRECORDCOUNT;
receiving a selection of the RECORDCOUNT value or the CHECKRECORDCOUNT value; and
updating the RECORDCOUNT value.

7. The method of claim 1, further comprising:
if RECORDCOUNT is not activated for the first database structure:
locking a global structure of the database; and
completing a count of the records.

8. The method of claim 7, wherein RECORDCOUNT is not activated for the first database structure if RECORDCOUNT =FALSE.

9. A computer system for performing structure-specific locking for a record count database operation by a database, the computer system comprising:
at least one processing unit; and
memory storing computer executable instructions that, when executed by the at least one processing unit, perform a method of:
defining a Data Definition Language (“DDL”) syntax for RECORDCOUNT which operates on a first structure in the database, wherein the first structure comprises at least a first record;
adding a second record to the first structure;
determining if RECORDCOUNT is enabled for the first structure; and
if RECORDCOUNT is enabled for the first structure:
locking the first structure;
determining a total number of records in the first structure;
providing the total number of records in the first structure; and
providing a timestamp identifying a time value of when the total number of records in the first structure was determined.

10. The system of claim 9, further comprising:
providing a datestamp with the returning of the total number of records in the first structure, wherein the datestamp identifies a date value of when the total number of records in the first structure was determined.

11. The system of claim 9, further comprising:
maintaining a second structure, wherein the second structure comprises a plurality of records; and
not locking the second structure while locking the first structure.

12. The system of claim 9, wherein RECORDCOUNT is stored in a control file.

13. The system of claim 9, wherein the determining if RECORDCOUNT is enabled for the first structure comprises:
determining if RECORDCOUNT=TRUE.

14. The system of claim 9, wherein RECORDCOUNT is not enabled for the first structure if RECORDCOUNT=FALSE.

15. The system of claim 14, further comprising:
if RECORDCOUNT is not activated for the first structure:
locking a global structure of the database.

16. The system of claim 9, further comprising:
determining a value for RECORDCOUNT is corrupted;
checking the value for RECORDCOUNT by employing a CHECKRECORDCOUNT option to provide a CHECKRECORDCOUNT value; and
if the value for RECORDCOUNT and the value for CHECKRECORDCOUNT differ:
displaying the value for RECORDCOUNT and the value for CHECKRECORDCOUNT;
receiving a selection of the RECORDCOUNT value or the CHECKRECORDCOUNT value; and
updating the RECORDCOUNT value.

17. A non-transitory computer readable medium comprising a database function for counting records, the database function comprising the following:
function syntax, wherein the function syntax comprises a string specifying the name RECORDCOUNT, and wherein RECORDCOUNT comprises instructions to count a number of records in a first structure, the instructions, when executed:
locking the first structure;
counting the number of records in the first structure;
providing the number of records in the first structure; and
providing a timestamp identifying a time of performance of the counting of the number of records in the first structure;
activation syntax, wherein the activation syntax comprises a value to cause at least one processing unit to perform the function RECORDCOUNT; and
structure syntax, wherein the structure syntax defines a database structure upon which the RECORDCOUNT function executes.

18. The computer readable medium of claim 17, wherein the value for the activation syntax comprises TRUE to indicate that the RECORDCOUNT function is activated.

19. The computer readable medium of claim 17, wherein the value for the activation syntax comprises FALSE to indicate that the RECORDCOUNT function is not activated.

20. The computer readable medium of claim 17, wherein the function syntax is a Data Definition Language (“DDL”) syntax, and wherein RECORDCOUNT is a structure physical option.
